(19) United States
(12) Patent Application Publication
(10) Pub. No.: US 2017/0102682 A1
(43) Pub. Date: Apr. 13, 2017

(54) Method and Apparatus for Using an Additive-Manufacturing Platform

(71) Applicant: Wal-Mart Stores, Inc., Bentonville, AR (US)

(72) Inventors: Donald R. High, Noel, MO (US); John P. Thompson, Bentonville, AR (US); Michael D. Atchley, Springdale, AR (US)

(21) Appl. No.: 15/278,634

(22) Filed: Sep. 28, 2016

Related U.S. Application Data
(60) Provisional application No. 62/239,681, filed on Oct. 9, 2015.

(51) Int. Cl. G05B 19/042; B33Y 50/02; B33Y 80/00; G06Q 30/06; B33Y 30/00

(52) U.S. Cl. CPC G05B 19/0426; G06Q 30/0621; B33Y 30/00; B33Y 80/00; B33Y 50/02; G05B 2219/49023

(57) ABSTRACT

A control circuit detects a trigger event that corresponds to a particular individual and responds by using an additive-manufacturing platform to manufacture an item for that particular individual. By one approach the manufactured item has at least one substantial physical attribute that is unknown (i.e., unexpected) to the particular individual. For example, that substantial physical attribute can comprise an attribute that is readily visually ascertainable. By one approach, the trigger event comprises a visit by the particular individual to a retail shopping facility. By another approach, in lieu of the foregoing or in combination therewith, the trigger event comprises the particular individual having achieved a particular game-play result.

### CROSS-REFERENCE TO RELATED APPLICATION

This application claims the benefit of U.S. Provisional Application No. 62/239,681 filed Oct. 9, 2015, and is incorporated herein by reference in its entirety.

### TECHNICAL FIELD

These teachings relate generally to additive manufacturing.

### BACKGROUND

Additive manufacturing, sometimes loosely referred to as 3-D printing, comprises a known and active area of endeavor. Additive manufacturing refers generally to any of a variety of processes that manufacture three-dimensional objects by adding in a successive manner constituent raw material. So-called 3-D printers add that content through a plurality of successively-applied layers. In these regards additive manufacturing stands in stark contrast to other manufacturing techniques such as casting or molding, fabrication, stamping, and machining.

Additive manufacturing processes can accommodate a wide variety of raw materials including metals and plastics. In many cases the additive manufacturing process utilizes a corresponding additive manufacturing model. Such a model typically comprises a three-dimensional model of the desired object and is typically created using computer-aided design, a 3-D scanner (to scan an object that is to serve as the basis for the model), or other related techniques. Additive-manufacturing models are typically expressed via corresponding modeling software.

Generally speaking, additive manufacturing is typically viewed as a way for an individual of enterprise to obtain an article that precisely conforms to their personal specific requirements even though those requirements might be highly customized and unique to that individual or enterprise application setting.

### BRIEF DESCRIPTION OF THE DRAWINGS

The above needs are at least partially met through provision of the method and apparatus for using an additive-manufacturing platform described in the following detailed description, particularly when studied in conjunction with the drawings, wherein:

FIG. 1 comprises a flow diagram as configured in accordance with various embodiments of these teachings; and

FIG. 2 comprises a block diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a control circuit detects a trigger event that corresponds to a particular individual and responds by using an additive-manufacturing platform to manufacture an item for that particular individual. By one approach the manufactured item has at least one substantial physical attribute that is unknown (i.e., unexpected) to the particular individual. For example, that substantial physical attribute can comprise an attribute that is readily visually ascertainable. By one approach, the entire form factor of the manufactured item may be unknown to the particular individual prior to the individual taking possession of the item.

These teachings will accommodate a variety of trigger events. By one approach, the trigger event comprises a visit by the particular individual to a retail shopping facility. By another approach, in lieu of the foregoing or in combination therewith, the trigger event comprises the particular individual having achieved a particular game-play result.

These teachings are highly flexible in practice and will accommodate numerous variations and modifications. As one example in these regards, these teachings will include determining a present age of the particular individual and using that present age to select an age-appropriate item to manufacture as the item. As another example in these regards, these teachings will accommodate identifying a part of a multi-part, composite item that has not been previously provided in full to the particular individual and selecting that part as the item to be manufactured for the particular individual.

These teachings will also accommodate leveraging whatever general or specific information may be available regarding the particular individual. In particular, that information can help to inform the selection of the particular item to be manufactured for the particular individual. Examples in these regards include, but are not limited to, selecting an age-appropriate item, a gender-appropriate item, a culturally-appropriate item, an affinity-appropriate item, and so forth as a function, at least in part, of such information.

So configured, by one approach the particular individual can be provided with a reward for visiting a retail shopping facility or other supported venue. That reward can include an exciting element of surprise to the extent that at least one substantial physical attribute of the item is unknown to the individual until the item is provided to that individual. In that case the ability of additive manufacturing to create a relatively unique item can be leveraged to surprise an intended recipient with a uniquely appropriate item.

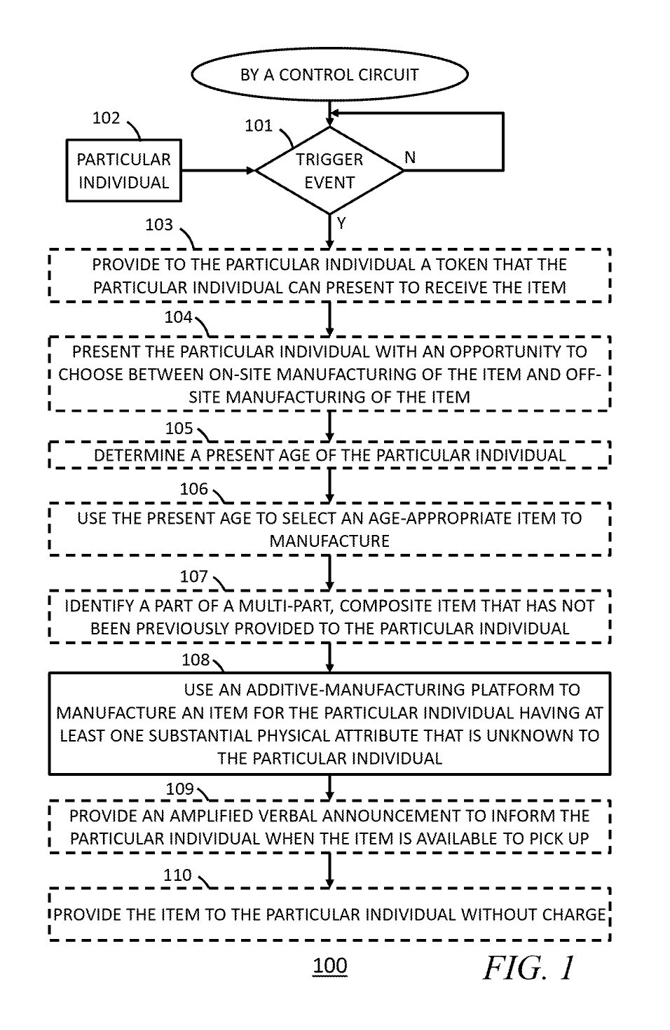

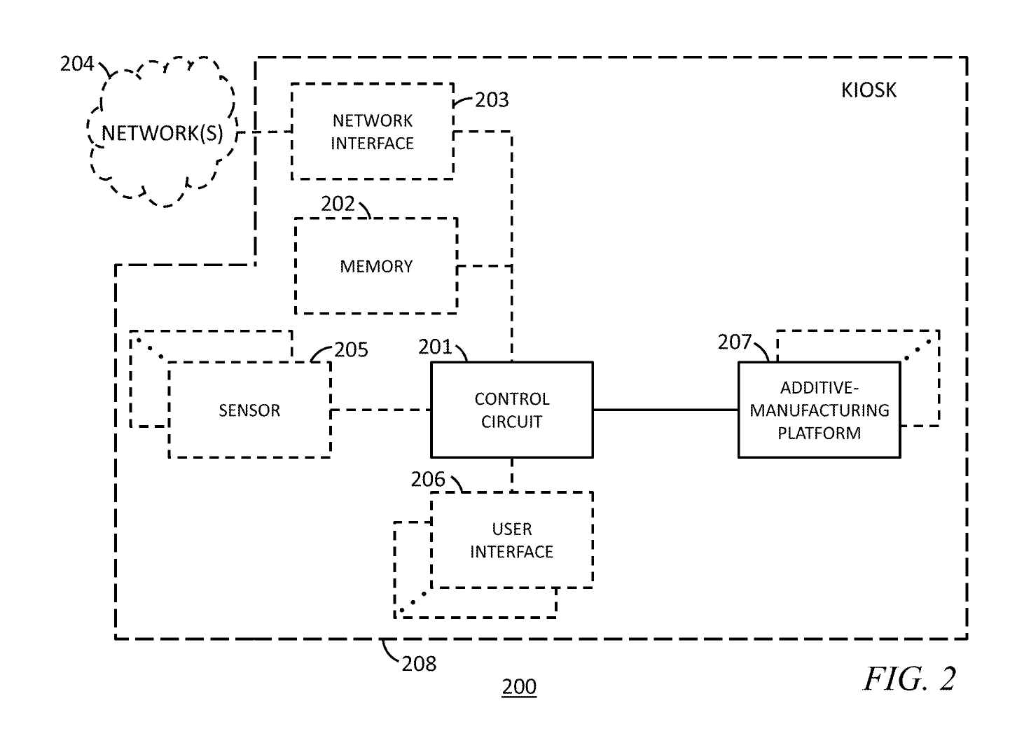

These and other benefits may become clearer upon making a thorough review and study of the following detailed description. Referring now to the drawings, and in particular to FIG. 1, an illustrative process 100 that is compatible with many of these teachings will now be presented. For the sake of an illustrative example it will be presumed in this description that a control circuit (or plurality of control circuits) carries out the actions, steps, and functions described in this process 100. FIG. 2 provides an illustrative example in these regards.

As shown in FIG. 2, an additive-manufacturing station 200 can include or otherwise operably couple to a control circuit 201. Being a “circuit,” the control circuit 201 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 201 can comprise a hardware platform that is a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 201 is configured (for example, by using corresponding programming as will be well understood by those skilled in the art) to carry out one or more of the steps, actions, and/or functions described herein. It will also be understood that a “control circuit” can comprise multiple such components or platforms if desired.

By one optional approach the control circuit 201 operably couples to a memory 202. This memory 202 may be integral to the control circuit 201 or can be physically discrete (in whole or in part) from the control circuit 201 as desired. This memory 202 can also be local with respect to the control circuit 201 (where, for example, both share a common circuit board, chassis, power supply, and/or housing) or can be partially or wholly remote with respect to the control circuit 201 (where, for example, the memory 202 is physically located in another facility, metropolitan area, or even country as compared to the control circuit 201).

In addition to one or more additive manufacturing models this memory 202 can serve, for example, to non-transitorily store the computer instructions that, when executed by the control circuit 201, cause the control circuit 201 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

If desired the control circuit 201 can also operably couple to a network interface 203. That network interface 203 can, in turn, operably couple to one or more networks 204 to thereby permit the control circuit 201 to communicate with a variety of remote resources and/or users. The network can comprise any of a variety of wireless and/or non-wireless networks as desired. By one approach at least one of the operably coupled networks comprises the Internet (i.e., the global system of interconnected computer networks that use the Internet protocol suite (TCP/IP)).

Examples of remote resources include, but are certainly not limited to, personal-information databases, demographics-correlated databases (containing, for example, items and/or affinity interests that typically correspond to particular demographically-based groups or individuals), additive-manufacturing models, communication services (including email, texting, and any of a variety of social networking services), and so forth.

Depending upon the application setting the control circuit 201 can also optionally operably couple to one or more sensors 205. Examples in these regards include, but are not limited to, still-image digital cameras, digital video cameras, thermal sensors, height sensors, weight sensors, and so forth. Generally speaking, such a sensor 205 can serve to help the control circuit 201 better determine when a user is present and/or one or more defining or distinguishing attributes or characteristics of such a user.

Also depending upon the application setting the control circuit 201 can optionally operably couple to one or more user interfaces 206. This user interface 206 can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to a user. By one approach, the user interface 206 can include a financial transaction-support mechanism to permit receiving currency, printed coupons, credit/debit cards information and/or tokens as provided by a user in exchange, for example, an additively-manufactured item. So configured, the control circuit 201 can interact directly with a given user.

In addition to the foregoing, these teachings provide for operably coupling one or more additive-manufacturing platforms 207 to the control circuit 201. For the sake of an illustrative example, the remainder of this description will presume that at least one of the additive-manufacturing platforms 207 comprises a three-dimensional (3-D) printer that utilizes plastic material to form a manufactured item. Generally speaking, additive-manufacturing platforms of various kinds are well known in the art as is their manner of use. Accordingly, for the sake of brevity further elaboration in those particular regards is not provided here.

One or more of the foregoing components can be housed in a corresponding kiosk 208. As used herein it will be understood that a kiosk comprises a standalone cabinet-like form factor that will typically include some user interface capability and that will, in this case, serve as a delivery platform for an additively-manufactured item. Such a kiosk will typically include portions that are taller than 3 feet.

That said, these teachings are highly flexible in these regards. By one simple approach the kiosk 208 may only comprise an additive-manufacturing platform 207. In that case, the additive-manufacturing platform 207 can operably couple to a remotely-located control circuit 201 that itself couples to other remotely-located components as desired. By another approach such a kiosk 208 can itself include at least one additive-manufacturing platform 207, the control circuit 201, and at least one user interface 206. Other permutations in these regards are of course possible.

By yet another approach the kiosk 208 may only comprise a holding area where an additively-manufactured item can be stored pending delivery of that item to a particular individual. In that case one or all of the other described components can be located in a non-public area of, for example, a retail shopping facility. When the additive-manufacturing platform 207 completes additively manufacturing a particular item for a particular individual, that manufactured item could then be taken to the kiosk 208 and placed therein to await the particular individual's arrival. The delivery of the item might be handled by an associate or by a terrestrial or airborne drone as desired.

With continued reference to both FIGS. 1 and 2, at decision block 101 the process 100 detects a trigger event that corresponds to a particular individual 102. In the case where the aforementioned kiosk 208 includes at least a user interface 206, and where the kiosk 208 is located in a public area of a retail shopping facility, that trigger event can simply comprise detecting that the particular individual is presently visiting that retail shopping facility. By one approach, for example, this individual may present themselves at the kiosk 208 to the user interface 206 and, for example, log in using previously-established credentials (where “previous” refers to prior to this particular visit).

By another approach, this individual may have an app on their smart phone. That app may be offered by and/or supported or controlled by the retail shopping facility. In this case the app may use various capabilities of the smart phone (such as location-determination capabilities and/or wireless conductivity capabilities (such as a Wi-Fi or Bluetooth-based conductivity)) to detect that this individual is presently visiting the retail shopping facility.

As another example, this detection activity can comprise detecting that the particular individual 102 has achieved a particular video game-play result. These teachings are highly flexible in these regards. Accordingly, that game-play result might be achieved via a smart phone-based application, a browser-based interface, or even at the kiosk 208 itself when the latter is configured to also serve as a stand-alone game kiosk.

Upon detecting the aforementioned trigger event 101, the control circuit 201 can respond in a variety of different ways. Some of those different ways will now be described. It should be understand that at least some of these different ways can be combined with one another and are not necessarily mutually exclusive as regards their use.

At optional block 103, the control circuit 201 can provide to the particular individual a token that the particular individual 102 can present at the kiosk 208 to receive an additively-manufactured item. This token can comprise a physical token such as a coin-like object or a coupon-like document. In either case the token can include identifying information and one or more security elements to permit validation of the token for the aforementioned intended use. By another approach the token can comprise a virtual token such as a code that the particular individual 102 will enter at the kiosk 208 via, for example, a physical keypad or a touchscreen as comprises a part of a user interface 206 provided thereat. As another example in these regards, the token can comprise one or more codes that are wirelessly transmitted to, for example, a smart phone via, for example, Bluetooth transmissions or Near Field Communications (NFC). That smart phone can then be presented at the kiosk 208 where a corresponding capability as comprises a part of the user interface 206 can receive the token to facilitate the described object.

At optional block 104 the control circuit 201 presents the particular individual 102 (via, for example, the aforementioned user interface 206) with an opportunity to choose between on-site manufacturing of an item to be additively manufactured and off-site manufacturing of the same item (where “on-site” refers in this example to somewhere at the retail shopping facility and “off-site” refers to a location other than at the retail shopping facility that features the kiosk 208).

Additively-manufacturing a given item at high resolution, for example, can potentially require a considerable amount of time. In particular, an amount of time that may exceed a duration that is reasonable in the context of the use anticipated for the aforementioned kiosk. In that case, by providing the particular individual 102 with the option of having the item manufactured at an off-site facility where a high-resolution result can be attained the needs and/or expectations of the particular individual can be met without unduly burdening the on-site facility with such a task. The foregoing “opportunity” can be as simple as presenting to the particular individual 102 on a display the two manufacturing possibilities along with a corresponding checkbox by which the user selects the desired platform.

At optional block 105, the control circuit 201 determines a present age of the particular individual. By one approach, where the particular individual 102 provides age -related information when presently or previously registering with the retail shopping facility (for example, via a corresponding smart phone app for that retail shopping facility) the control circuit 201 can access that age information via, for example, a corresponding local or remote resource. By another approach, where one or more of the aforementioned sensors 205 comprise, for example, a digital camera, one or more captured images of the particular individual 102 (when presenting themselves, for example, at the kiosk 208) can be processed to thereby automatically characterize various demographics of the particular individual 102 such as their likely age. (Techniques and methods for so characterizing an individual based on a digitally-captured image comprises a known area of prior art endeavor that requires no further description here.)

At optional block 106 the control circuit 201 then uses that determined present age of the particular individual 102 to select an age-appropriate item to manufacture. As one simple example in these regards, this selection can comprise avoiding a manufactured item having one or more small parts that might represent a choking hazard to a very young individual. As another example in these regards, this selection can comprise avoiding manufacturing an item that comprises a child's toy for an obviously-mature individual.

As yet another example in these regards, at optional block 107 the control circuit 201 can identify a part of a multi-part, composite item, which part has not been previously provided to the particular individual 102 (as determined, for example, by accessing local and/or remote records in those regards). So configured, a resultant multi-part composite item can be eventually constructed by the individual 102 having a size whose dimensions exceed the manufacturing capabilities of the additive-manufacturing platform 207 itself. When making this determination the control circuit 201 may access one or more local or remote resources regarding the particular individual 102 and previously-manufactured items that were already provided to this particular individual 102 that also constitute a part of the same multi-part composite item.

At block 108 the control circuit 201 uses the aforementioned additive-manufacturing platform 207 to manufacture an item for the particular individual 102 wherein that item has at least one substantial physical attribute that is unknown to the particular individual. This does not mean that the physical attribute is unknown to the particular individual in a more general sense. For example, the item might have the form factor of a cube and it might be expected that the particular individual 102 will be generally familiar with cubes. In the present case, however, the particular individual 102 will not yet know that the item to be manufactured is going to be shaped like a cube, and hence in that sense the cube shape is “unknown” to the particular individual 102.

By one approach, the physical attribute is “substantial” in that it is readily visually ascertainable. As used herein the reference to being “readily visually ascertainable” shall be understood to refer to a feature that is visually perceptible in ordinary light by a person having (corrected or otherwise) at least 20-40 vision from a distance of 0.5 meter. Being “perceptible” means that the feature is not merely noticeable as “something,” but can in fact be understood by at least the average human observer for what it is. For example, if the physical attribute constitutes text, that text must be of sufficient size and clarity to permit the individual characters of the text to be readable as per the foregoing and not merely vaguely discernable as alphabetic characters without any certainty regarding which alphabetic characters they are.

As another example in these regards, the particular individual 102 may know, understand, or even guess that they are likely to receive an item that comprises a part of a multi-part, composite item that is itself known to them. That said, however, the manufactured item itself can be unknown to the particular individual 102 in that the particular individual 102 does not know which part of the multi-part, composite item is being manufactured. Accordingly, such an item itself constitutes the substantial physical attribute that is unknown to the particular individual.

As noted above, in some cases there may be both an on-site additive manufacturing platform as well as an off-site additive-manufacturing platform. It is also possible that there are multiple on-site additive manufacturing platforms and/or multiple off-site additive-manufacturing platforms. These teachings will support having the control circuit 201 select one or more of these available options when manufacturing the aforementioned item. That selection can be based upon any of a variety of factors such as, for example, a currently-expressed or a previously-registered preference on the part of the particular individual 102, suitability of a particular platform to manufacture a particular item (in terms of utilized material, manufacturing time requirements, resolution capabilities, and so forth), present queuing (where, for example, one additive-manufacturing platform has a relatively lengthy backlog of items to manufacture in comparison to another platform that is presently awaiting a manufacturing task), and so forth.

In some cases, as when the particular individual effects the aforementioned trigger event prior to visiting, for example, the corresponding retail shopping facility, the control circuit 201 can use the additive-manufacturing platform 207 to manufacture the item for that individual prior to when the particular individual 102 visits the retail shopping facility to receive the item. In other cases, as when the particular individual effects the aforementioned trigger event while visiting the retail shopping facility, the control circuit 201 can use the additive-manufacturing platform 207 to manufacture the item while that individual is at the retail shopping facility.

In some cases the particular individual 102 may choose to visit other parts of the retail shopping facility while the item is manufactured. To accommodate such a circumstance these teachings will accommodate having the control circuit 201 provide an alert to the particular individual 102 when the item is available to pick up. By one approach, as represented by optional block 109, the control circuit 201 can provide an amplified general verbal announcement via an in-facility audio speaker system at the retail shopping facility to inform the particular individual 102 when the item is available for pickup. By another approach, in lieu of the foregoing or in combination therewith, the control circuit 201 can cause an alert to be wirelessly transmitted to, for example, a smart phone that is associated with the particular individual 102. That alert can be conveyed in any of a variety of ways including as an email, a text message, or an app-based alert.

At optional block 110 the control circuit 201 provides the item to the particular individual 102 without charge. For example, the manufactured item may be placed in a closed area (comprising, for example, a part of the aforementioned kiosk 208) that is secured against unauthorized entry. Upon presenting a token as described above, that closed area can be unlocked to permit the particular individual 102 to access that area and retrieve their item. In other cases, as when the particular individual 102 is known to be present at the kiosk 208 while the item is manufactured, the manufactured item can simply be placed in a receiving area upon completion such that the particular individual 102 can take the item when the item becomes available.

So configured, the interest factor of an additive-manufacturing process can be coupled with the interest factor of a welcome surprise to provide a compelling basis for encouraging a particular individual to visit a given retail shopping facility or other enabling venue.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A method comprising:
by a control circuit:
detecting a trigger event corresponding to a particular individual;
in response to detecting the trigger event, using an additive-manufacturing platform to manufacture an item for the particular individual having at least one substantial physical attribute that is unknown to the particular individual.

2. The method of claim 1 wherein the trigger event comprises, at least in part, a visit by the particular individual to a retail shopping facility.

3. The method of claim 2 further comprising:
providing the item to the particular individual without charge.

4. The method of claim 1 further comprising:
determining a present age of the particular individual;
using the present age to select an age-appropriate item to manufacture as the item.

5. The method of claim 1 wherein the item comprises a component of a multi-part, composite item.

6. The method of claim 5 further comprising:
identifying a part of the multi-part, composite item that has not been previously provided to the particular individual;
and wherein manufacturing the item for the particular individual comprises manufacturing the part of the multi-part, composite item that has not been previously provided to the particular individual as the item.

7. The method of claim 1 wherein the at least one substantial physical attribute comprises an attribute that is readily visually ascertainable.

8. The method of claim 1 wherein using the additive-manufacturing platform to manufacture the item for the particular individual occurs prior to the particular individual visiting a retail shopping facility to receive the item.

9. The method of claim 1 further comprising:
providing to the particular individual a token that the particular individual can present to receive the item.

10. The method of claim 1 wherein the trigger event comprises the particular individual having achieved a particular game-play result.

11. The method of claim 10 wherein the particular game-play result is achieved via at least one of:
a smartphone-based application;
a browser-based interface;
a stand-alone game kiosk.

12. The method of claim 1 wherein using the additive-manufacturing platform to manufacture the item comprises:
presenting the particular individual with an opportunity to choose between on-site manufacturing of the item and off-site manufacturing of the item.

13. The method of claim 1 further comprising:
providing an amplified verbal announcement to inform the particular individual when the item is available to pick up.

14. An apparatus comprising:
a control circuit configured to:
detect a trigger event corresponding to a particular individual;
in response to detecting the trigger event, use an additive-manufacturing platform to manufacture an item for the particular individual having at least one substantial physical attribute that is unknown to the particular individual.

15. The apparatus of claim 14 wherein the control circuit is further configured to:
determine a present age of the particular individual;
use the present age to select an age-appropriate item to manufacture as the item.

16. The apparatus of claim 14 wherein the item comprises a component of a multi-part, composite item.

17. The apparatus of claim 16 wherein the control circuit is further configured to:
identify a part of the multi-part, composite item that has not been previously provided to the particular individual;
and wherein the control circuit manufactures the item for the particular individual by manufacturing the part of the multi-part, composite item that has not been previously provided to the particular individual as the item.

18. The apparatus of claim 14 wherein the at least one substantial physical attribute comprises an attribute that is readily visually ascertainable.

19. The apparatus of claim 14 wherein the control circuit is configured to use the additive-manufacturing platform to manufacture the item for the particular individual prior to the particular individual visiting a retail shopping facility to receive the item.

20. The apparatus of claim 14 wherein the control circuit is further configured to present the particular individual with an opportunity to choose between on-site manufacturing of the item and off-site manufacturing of the item.
